(19) United States
(12) Patent Application Publication
(10) Pub. No.: US 2023/0181954 A1
(43) Pub. Date: Jun. 15, 2023

(54) SYSTEMS AND METHODS OF SPRINKLER BULBS WITH RESISTIVE TRACE

(71) Applicant: Tyco Fire Products LP, Lansdale, PA (US)

(72) Inventors: Pedriant Pena, Bellingham, MA (US); Cassandra Lyn DeNunzio, Cranston, RI (US); Gary Luiz, Warwick, RI (US); Scott Macomber, Johnston, RI (US); Arash Agan, Pawtucket, RI (US); Romero James Silvestre, Coventry, RI (US); Christopher Grayson, Richmond, RI (US)

(73) Assignee: Tyco Fire Products LP, Lansdale, PA (US)

(21) Appl. No.: 17/917,389

(22) PCT Filed: Apr. 27, 2021
(86) PCT No.: PCT/IB2021/053465

§ 371 Date: Oct. 6, 2022

Related U.S. Application Data
(60) Provisional application No. 63/016,710, filed on Apr. 28, 2020.

(51) Int. Cl. A62C 37/14

(52) U.S. Cl. CPC A62C 37/14

(57) ABSTRACT

A sprinkler system includes a sprinkler and a release assembly. The sprinkler includes a base defining an inlet and an outlet, at least one arm extending from the base, a deflector coupled with the at least one arm, a button that seals the outlet, and a bulb coupled with the button between the button and the deflector. The bulb includes a resistive trace made of an electrically conductive material to fracture the bulb responsive to an electrical current to release the button from the outlet. The release assembly is coupled with the sprinkler and provides the electrical current to the bulb to cause the bulb to fracture responsive to a fire condition.

### CROSS-REFERENCE TO RELATED APPLICATIONS

The present application claims the benefit of priority to U.S. Provisional Application No. 63/016,710, filed Apr. 28, 2020, the disclosure of which is incorporated herein by reference in its entirety.

### BACKGROUND

Fire suppression systems can be provided in buildings to address fire conditions. Fire suppression systems can include fire protection sprinklers that connect with piping systems to receive fluid to address the fire conditions.

### SUMMARY

At least one aspect relates to a sprinkler system. The sprinkler system includes a sprinkler and a release assembly. The sprinkler includes a base defining an inlet and an outlet, at least one arm extending from the base, a deflector coupled with the at least one arm, a button that seals the outlet, and a bulb coupled with the button between the button and the deflector. The bulb includes a resistive trace made of an electrically conductive material to fracture the bulb responsive to an electrical current to release the button from the outlet. The release assembly is coupled with the sprinkler and provides the electrical current to the bulb to cause the bulb to fracture responsive to a fire condition.

At least one aspect relates to a fire suppression system. The fire suppression system includes at least one nozzle, a release assembly, and an activation device. The at least one nozzle includes an outlet sealed by a button and a bulb in contact with the button. The bulb includes an electrically conductive material to cause the bulb to fracture responsive to receiving an electrical current. The release assembly is coupled with the electrically conductive material to provide the electrical current to the electrically conductive material. The activation device can cause the release assembly to provide the electrical current to the electrically conductive material responsive to a fire condition corresponding to a temperature less than a temperature rating of the bulb.

At least one aspect relates to a fire suppression system. The fire suppression system includes a plurality of nozzles, a release assembly coupled with each nozzle of the plurality of nozzles, a pipe, and a detection device. Each nozzle of the plurality of nozzles includes a base, a first arm and a second arm, a set screw, a button, and a bulb coupled with the button and the set screw. The bulb is made of a material that can conduct electrical current and fracture in response to electrical current flowing through and the button falls from each nozzle in response to the bulb fracturing. The pipe accepts the plurality of nozzles. The detection device senses a fire condition and send an activation signal to the release assembly in response. The release assembly provides an electric current to each nozzle of the plurality of nozzles in response to the activation signal, and the bulb fractures when electric current passes through the bulb to activate the fire suppression system.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

FIG. 1 depicts an example of a fire suppression system.

FIG. 2 depicts an example of a release assembly.

FIG. 3 depicts an example of a release assembly.

FIG. 4 depicts an example of a release assembly.

FIG. 5 depicts an example of a release assembly.

FIG. 6 depicts an example of a release assembly.

FIG. 7 depicts an example of a release assembly.

FIG. 8 depicts an example of a release assembly.

FIG. 9 depicts an example of a release assembly.

FIG. 10 depicts an example of a release assembly.

FIG. 11 depicts an example of a release assembly.

FIG. 12 depicts an example of a release assembly.

FIG. 13 depicts an example of a release assembly.

FIG. 14 depicts an example of a release assembly.

FIG. 15 depicts an example of a metal clamp.

FIG. 16 depicts an example of a hose clamp.

### DETAILED DESCRIPTION

The present disclosure relates generally to fire suppression systems, including fire suppression systems. More particularly, the present disclosure relates to systems and methods of sprinklers that include thermal triggers including a bulb having a resistive trace.

Fire suppression systems include sprinklers, which define an outlet for fire suppressant (e.g., fluid, water, fire suppressant agent). The outlet facilitates dispersing of the fire suppressant over a hazard area. Dispersing of fire suppressant is facilitated by fracturing (e.g., removal, breaking) of a bulb (e.g., glass bulb) positioned within the sprinkler. The bulb limits flow of fire suppressant flowing from the sprinkler by forming a fluid seal with an outlet of the sprinkler. In response to a fire condition, the bulb fractures and the outlet is unsealed, allowing fluid flow out of the outlet.

In some fire suppression systems, the bulb fractures in response to heat from a fire, or a heated surface. As the heat rises, the bulb increases in temperature. Once the bulb reaches a threshold temperature, the bulb fractures. Systems and methods as described herein can enable the bulb to react before the temperature of the fire or in a room rises above the threshold temperature. For example, the bulb can be electrically reactive. The bulb fractures in response to receiving electrical current from a source of electrical current. The source of electrical current can be a detector, a controller, or another source (e.g., circuit board, etc.).

The sprinkler and various other components of the system can be used for storage applications, including but not limited to use for ceiling-only systems, and for ceiling heights up to and over fifty five feet. For example, the system can be used for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof. The system can be used in accordance with various standards, such as standards set forth by the National Fire Protection Association (NFPA) or FM Global.

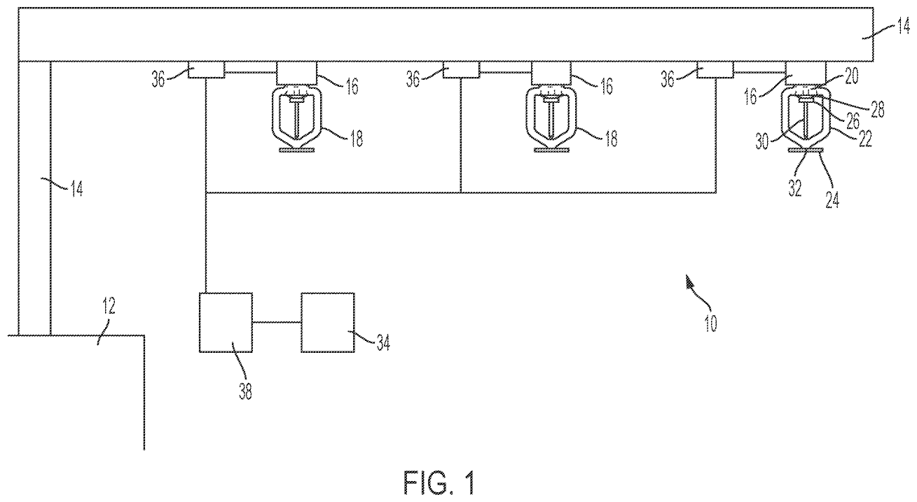

FIG. 1 depicts an example of a fire suppression system 10. The fire suppression system 10 can be installed within a room of a building. The fire suppression system 10 includes a source 12 of fire suppressant. The source 12 is structured to provide fire suppression agent (e.g., water, agent, etc.). The source 12 can define a volume structured to contain a quantity of fire suppression agent or can be a steady flow of fire suppression agent from a remote location (e.g., water tank, etc.). The source 12 can define an internal volume filled (e.g., partially filled, completely filled) with fire suppressant agent. The source 12 can provide fluid from a remote or local location to a building in which the fire suppression system 10 is located. The source 12 can include, for example, a municipal water supply, pump, piping system, tank, cylinder, or any other source of water or fire suppression agent. The fire suppression system 10 can be used with a variety of fire suppressant agents, including but not limited to water (e.g., can use powders, liquids, foams, or other fluid or flowable materials).

The source 12 is fluidly coupled with a pipe 14. The pipe 14 receives fire suppression agent from the source 12. The pipe 14 directs the fire suppression agent throughout the room or the building. The pipe 14 includes drop pipes 16. The drop pipes 16 extend from the pipe 14. Each drop pipe 16 couple with a nozzle 18 (e.g., sprinkler, such as an early suppression fast response (ESFR) sprinkler).

The nozzle 18 can direct and disperse the fire suppression agent into the room from the drop pipe 16. The fire suppression system 10 can include a manual activation device 34 and/or an automatic activation device 36 coupled with each of the nozzles 18. The manual activation device 34 and the automatic activation device 36 can send signals to a controller 38 or to the nozzle 18 to activate the fire suppression system 10 and release fire suppression agent. The nozzles 18 can be used as concealed sprinklers, pendent sprinklers, upright sprinklers, water mist nozzles, or any other device for spraying fire suppressant agent. The activation devices 34, 36 can include or be coupled with a detection device to detect a fire condition. The detection device can include one or more of a temperature sensor, a smoke detector, a heat detector, or a gas detector, and can be calibrated to output a detection signal indicative of the fire condition prior to the fire condition being sufficient to fracture the bulb 30 described herein (e.g., at a condition corresponding to a lower temperature than a temperature rating of the bulb 30, such as a temperature, rate of rise of temperature, gas, smoke, or particulate concentration, or other condition at which a fire condition may be detected even if the temperature associated with the fire condition at the location of the bulb 30 is less than the temperature rating of the bulb).

The nozzle 18 includes a base 20. The base 20 can define a portion to couple with the drop pipe 16. The base 20 can include threading that interfaces with threading on the drop pipe 16. The base 20 can define a flow through aperture from an inlet 42 that receives fluid from the pipes 14, 16 to an outlet 44. The flow aperture allows fire suppression agent to flow through the base 20. The nozzle 18 can include at least one arm 22 (e.g., frame arms) extending from the base 20.

The arms 22 can couple with a deflector 24. The arms 22 can space the deflector 24 from the flow aperture and the base 20. The deflector 24 can receive the fluid and output the fluid with a target spray pattern (e.g., based on the structure of the deflector 24).

The nozzle 18 can include a button 26, which can be used to seal the flow aperture (e.g., seal the outlet 44). The button 26 can be disposed in the outlet 44 to limit flow of fire suppressant from the nozzle 18. In some examples, an ejector spring 28 is disposed between the button 26 and the base 20. The ejector spring 28 exerts a force on the button 26 to force the button 26 from the outlet 44 to unseal the outlet 44.

The nozzle 18 can include a bulb 30. The bulb 30 can be between the deflector 24 and the button 26 to limit movement of the button 26 relative to the deflector 24, such as to apply force against the button 26 to hold the button 26 in the outlet 44. For example, the bulb 30 can apply a force on the button 26 greater than the spring force from the ejector spring 28.

The bulb 30 can include a resistive trace 50. The resistive trace 50 can be an electrically conductive material that has a resistance to electrical current flow in a range to cause the resistive trace 50 to generate heat responsive to receiving an electrical current (e.g., from activation devices 34, 36 or controller 38), which can cause the bulb 30 to fracture (e.g., by causing at least one of a gas in the bulb 30 to expand to fracture the bulb responsive to the heat and the bulb 30 to change state from a rigid state to a state at which a likelihood of fracture increases). For example, the resistance of the resistive trace can be different than the resistance of the glass of the bulb 30 (e.g., the glass of the bulb 30 can have relatively low electrical conductivity, such that the glass itself can not be able to be fractured responsive to the electrical current in the absence of the resistive trace 50). As such, the bulb 30 can be enabled to fracture responsive to the electrical current, including before a temperature from a fire condition meets or exceeds a temperature rating threshold of the bulb 30 (e.g., responsive to detection of the fire condition at a temperature less than the temperature rating threshold by the activation devices 34, 36, the controller 38, or a detection device coupled with the activation devices 34, 36 or the controller 38). The temperature rating can be any of 135, 155, 165, 175, 200, 214 or 286 degrees Fahrenheit; for example, the temperature rating can have a nominal value of any of 135, 155, 165, 175, 200, 214 or 286 degrees Fahrenheit, plus or minus twenty percent.

The nozzle 18 can include a set screw 32 extending through the deflector 24 to couple with the bulb 30. The set screw 32 can fixedly couple the bulb 30 with the deflector 24. At least some components of the nozzle 18 can be made of a conductive metal (e.g., copper, etc.). The ejector spring 28 can be made of a non-conductive material or can include a coating of a non-conductive material.

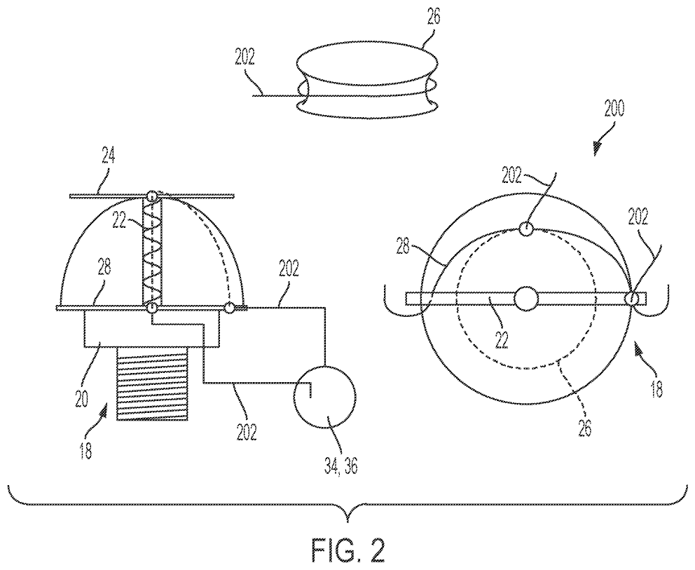

FIGS. 2-16 depict various examples of release assemblies. The release assembly can connect with the nozzle 18. The release assembly can be coupled with the nozzle 18 during manufacturing of the nozzle 18 or can be coupled during installation of the nozzle 18. The release assembly can receive signals from and send signals to the controller 38, the manual activation device 34, and/or the automatic activation device 36. The signals can include activation signals for or status signals of the release assembly. The release assembly, in response to receiving an activation signal, can transmit an electric current through the nozzle 18. The bulb 30 can complete a circuit for the electric current in the nozzle 18 and fractures in response to the electric currently being transmitted through (e.g., transmitted through the resistive trace 50). The circuit can begin in any of the components of the nozzle 18 (e.g., the arms 22, the base 20, the bulb 30, the base 20, the deflector 24, etc.). The circuit breaks responsive to fracture of the bulb 30.

FIG. 2 depicts an example of a release assembly 200. The release assembly 200 can couple with the nozzle 18. The release assembly 200 can include the ejector spring 28 coupled with the arms 22 and the button 26. The release assembly 200 can include one or more wires 202. The wires 202 can electrically couple the release assembly 200 with one or more of the activation devices 34, 36.

A first wire of the wires 202 can couple with the ejector spring 28 or the base 20. For example, the first wire of the wires 202 can wrap around the button 26. A second wire of the wires 202 can couple with the arms 22. An insulative material can be positioned between the ejector spring 28 and the arm 22 to limit current transmission between the ejector spring 28 and the arm 22. During activation, an electrical current is sent from the automatic activation device 36 through a wire of the wires 202 to the button 26, the ejector spring 28, or the arms 22. The electrical current travels through the bulb 30 and out of the arms 22, the ejector spring 28, or the arms 22. The bulb 30 fractures responsive to the electrical current, allowing the button 26 to be ejected from the outlet 44 (e.g., to activate the nozzle 18). For example, the electrical current can enter via the button 26 or the ejector spring 28, travels through the bulb 30, and exits via an arm 22. In another example, the electrical current enters via an arm 22, travels through the bulb 30, and exits via the button 26 or the ejector spring 28.

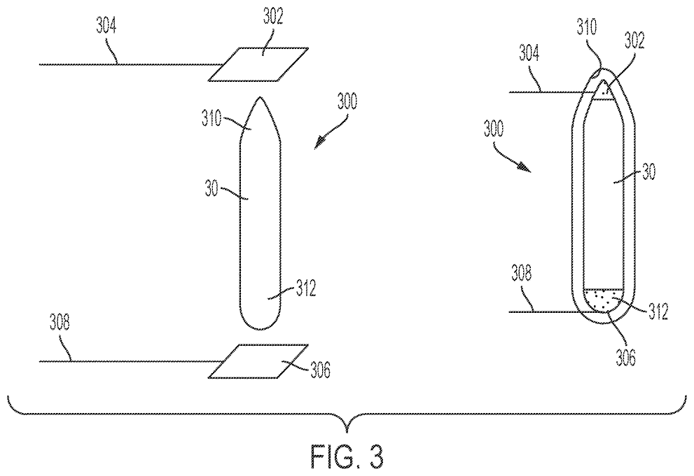

FIG. 3 depicts an example of a release assembly 300. The release assembly 300 can couple with the nozzle 18. A first metal sheet 302 can be coupled with a first wire 304 and a second metal sheet 306 can be coupled with a second wire 308. The first metal sheet 302 can be coupled with a first end 310 of the bulb 30 and the second metal sheet 306 can be coupled with a second end 312 of the bulb 30. The first metal sheet 302 and the second metal sheet 306 can be coupled with the bulb 30 during manufacturing of the nozzle 18. The bulb 30 can be provided with a coating (e.g., wax, etc.) after coupling of the first metal sheet 302 and the second metal sheet 306 to protect an integrity of the bulb 30. The first wire 304 and the second wire 308 can be coupled with the manual activation device 34, or the automatic activation device 36 during installation of the nozzle 18. An electric current can be sent through the bulb 30, causing fracture of the bulb 30 to allow release of the button 26 from the flow aperture to unseal the flow aperture. In an example, the electric current enters the bulb 30 via the first wire 304 and the first metal sheet 302 and exits via the second metal sheet 306 and the second wire 308. In an example, the electric current enters the bulb 30 via the second wire 308 and the first metal sheet 302 and exits via the first metal sheet 302 and the first wire 304.

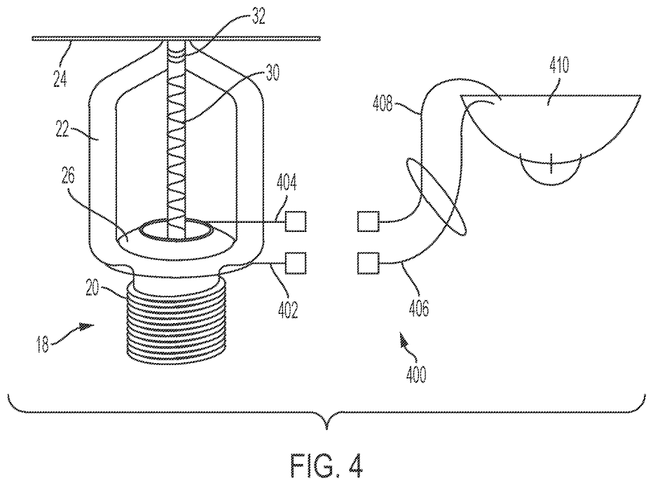

FIG. 4 depicts an example of a release assembly 400. The release assembly 400 can couple with the nozzle 18. The release assembly 400 can include a first rigid wire 402 and a second rigid wire 404. The first rigid wire 402 can be coupled with the base 20 of the nozzle 18 and extend around an outer circumference of the base 20. The second rigid wire 404 can be coupled with the button 26 of the nozzle 18 and extend around an inner circumference of the button 26. The button 26 and the base 20 can be separated via the ejector spring 28 or another non-conductive material. The first rigid wire 402 can couple with a first wire 406 of an activation device 410 (e.g., manual activation device 34, automatic activation device 36, etc.) and the second rigid wire 404 can couple with a second wire 408 of the activation device 410. Electrical current can be sent from the activation device 410, through the nozzle 18, and back to the activation device 410. In an example, the electrical current enters the nozzle 18 via the first wire 406 and the first rigid wire 402, travels through the base 20, the arms 22, the set screw 32, the bulb 30, and the button 26, and exits the nozzle 18 via the second rigid wire 404 and the second wire 408. In an example, the electrical current enters the nozzle 18 via the second wire 408 and the second rigid wire 404, travels through the button 26, the bulb 30, the set screw 32, the arms 22, and the base 20, and exits via first rigid wire 402 and the first wire 406. Electrical current passing through the bulb 30 can fracture the bulb 30 and allows the button 26 to exit the flow aperture and release fire suppression agent through the flow aperture. The first rigid wire 402, the first wire 406, the second rigid wire 404, and the second wire 408 can have color coding to help an installer during installation of the nozzle 18 to connect the correct wires.

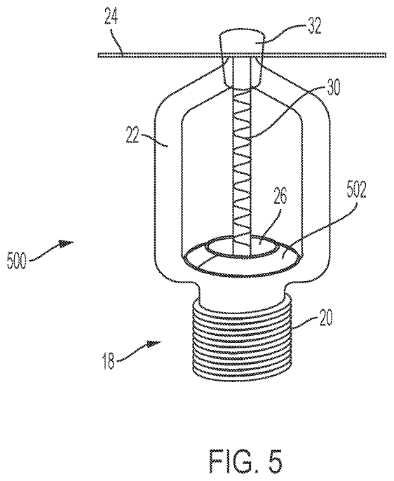

FIG. 5 depicts an example of a release assembly 500. The release assembly 500 can couple with the nozzle 18. The release assembly 500 can include a printed circuit board (PCB) 502. The PCB 502 can include conductors positioned on an outer perimeter and an inner perimeter. The PCB 502 can be positioned between the base 20 and the button 26. The outer perimeter of the PCB 502 can contact the base 20 and the inner perimeter of the PCB 502 can contact the button 26. The PCB 502 can include a power source or can be connected to a detection device (e.g., the manual activation device 34 or the automatic activation device 36, etc.). The PCB 502 can receive an activation signal or an electrical current from the detection device. In some examples, the electrical current enters the nozzle 18 via the base 20, travels through the arms 22, the set screw 32, and the bulb 30, and exits via the button 26. In some examples, the electrical current enters the nozzle 18 via the button 26, travels through the bulb 30, the set screw 32, and the arms 22, and exits via the base 20. The bulb 30 can fracture in response to electrical current going through the bulb 30, causing the button 26 to exit the flow aperture and allow the release of fire suppression agent. The PCB 502 can include an underside made of waterproof material to limit shorting before activation. In some examples, the PCB 502 monitors the nozzle 18 to determine if the bulb 30 has fractured (e.g., based on whether the circuit for the electrical current through the bulb 30 is detected to be open or closed). The PCB 502 can communicate information regarding the bulb 30, such as state of the bulb 30 (e.g., fractured or not fracture) to the detection device or the controller 38.

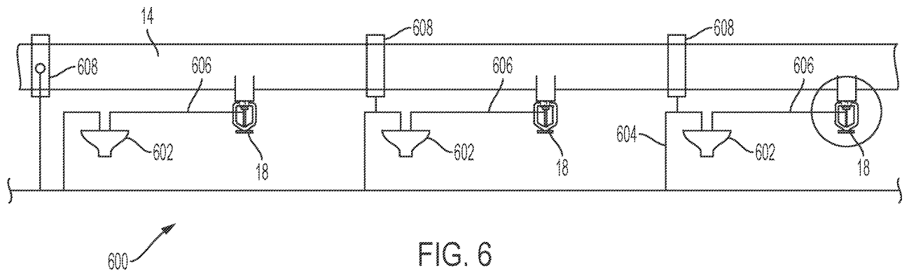

FIG. 6 depicts an example of a release assembly 600. The release assembly 600 can be connected with the fire suppression system 10. The release assembly 600 can couple with the pipe, a detection device 602 (e.g., the manual activation device 34, the automatic activation device 36, etc.), and the nozzle 18. The release assembly 600 can include a first wire 604 and a second wire 606. The first wire 604 can electrically couple the pipe 14 with the detection device 602. The first wire 604 can be coupled with the pipe 14 via a clamp 608. The second wire 606 can electrically couple the nozzle 18 with the detection device 602. The second wire 606 can be coupled with the bulb 30, the base 20, the button 26, or the arms 22. An electrical current passes through the bulb 30 of the nozzle 18, regardless of the component of the nozzle 18 the second wire 606 couples with. The detection device 602 can supply electrical current to the first wire 604 or the second wire 606. In an example, the electrical current enters the pipe via the first wire 604, travels through the pipe 14, the nozzle 18, the bulb 30, and exits via the second wire 606. In an example, the electrical current enters the nozzle 18 via the second wire 606, travels through the bulb 30, the pipe 14, and exits via the first wire 604.

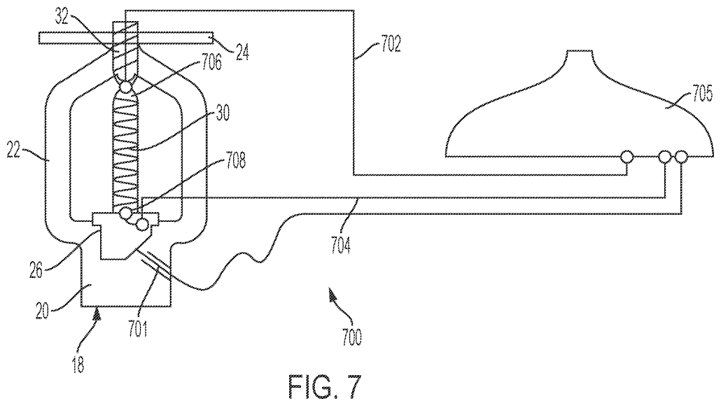

FIG. 7 depicts an example of a release assembly 700. The release assembly 700 couple with the nozzle 18. The release assembly 700 can include a pogo pin 701. The pogo pin 701 can interface with or contact the button 26. The pogo pin 701 can be positioned within the flow aperture or can be positioned on an external surface of the base 20. The release assembly 700 can include a first wire 702 and a second wire 704. The first wire 702 can couple with a first side 706 of the bulb 30 and with a detection device 705 (e.g., manual activation device 34, automatic activation device 36, etc.) and extend through the set screw 32. The set screw 32 can include an aperture that accepts the first wire 702. The set screw 32 and the first wire 702 can be electrically isolated, such that no current from the first wire 702 will enter the set screw 32. The set screw 32 can be made of a non-conductive material. The second wire 704 can couple with a second side 708 of the bulb 30 either directly or via the button 26 and/or the pogo pin 701 and with the detection device 705. The pogo pin 701 can form an electric path between the second wire 704 and the button 26 or can form an electric path directly between the second wire 704 and the bulb 30. The first side 706 of the bulb 30 can be opposite the second side 708 of the bulb 30. The button 26 can be made of a non-conductive material to limit current being conducted by the button 26 and traveling away from the bulb 30. In an example, an electric current is supplied by the detection device 705 and enters the nozzle 18 via the first wire 702, travels through the bulb 30, and exits via the second wire 704 and/or the pogo pin 701. In an example, an electric current is supplied by the detection device 705 and enters the nozzle 18 via the second wire 704, travels through the pogo pin 701 and/or the button 26, and the bulb 30, and exits via the first wire 702.

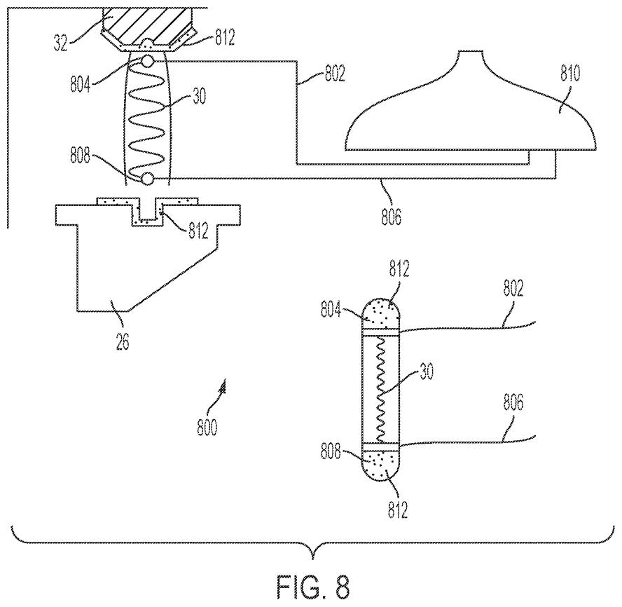

FIG. 8 depicts an example of a release assembly 800. The release assembly 800 can couple with the nozzle 18. The release assembly 800 can include a first wire 802 coupled directly with a first side 804 of the bulb 30 and a second wire 806 coupled directly with a second side 808 of the bulb 30. The bulb 30 can be electrically isolated from the set screw 32 and the button 26 via a non-conductive material disposed between the set screw 32 and the bulb 30, and the button 26 and the bulb 30. In some examples, the first side 804 and the second side 808 are coated with an insulation material 812 after the first wire 802 and the second wire 806 are coupled with the bulb 30. The first wire 802 and the second wire 806 can be wrapped around the bulb 30 or can be coupled via an adhesive. The first wire 802 and the second wire 806 can be coupled with a detection device 810 (e.g., the manual activation device 34, the automatic activation device 36, etc.) during installation of the nozzle 18. In some examples, the first wire 802 and the second wire 806 can couple with a pair of wires extending from the detection device 810. An electric current can be sent by the detection device 810 through the bulb 30, causing fracture of the bulb 30 to allow release of the button 26 from the flow aperture to unseal the flow aperture. In an example, the electric current enters the bulb 30 via the first wire 802 and exits via the second wire 806. In an example, the electric current enters the bulb 30 via the second wire 806 and exits via the first wire 802.

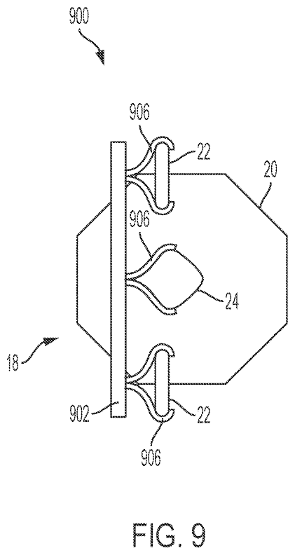

FIG. 9 depicts an example of a release assembly 900. The release assembly 900 can couple with the nozzle 18. The release assembly 900 can include a PCB 902. The PCB 902 can include frame clips 904 and a button clip 906. The frame clips 904 connect with the arms 22 of the nozzle 18 to secure the PCB 902 to the arms 22. The button clip 906 connect with the button 26 of the nozzle 18 to secure the PCB 902 to the button 26 before activation. The PCB 902 can electrically couple with the manual activation device 34 and/or the automatic activation device 36 to send/receive signals. The PCB 902 can receive electrical current or can send signals regarding an integrity of the bulb 30 (e.g., fractured, not fractured, etc.), which can be determined by continuity. The PCB 902 can also have a power source and receive an activation signal from the manual activation device 34 and/or the automatic activation device 36. Responsive to receiving the activation signal, the PCB 902 sends an electrical current into the nozzle 18. The button 26 and the base 20 can be electrically isolated from each other to limit current transfer between. In an example, the current enters the nozzle 18 via the frame clips 904, travels through the arms 22, the set screw 32, the bulb 30, and the button 26, and exits via the button clip 906. In an example, the current enters the nozzle 18 via the button clip 906, travels through the button 26, the bulb 30, the set screw 32, and the arms 22, and exits via the frame clips 904. If the current is not passed through the bulb 30 (e.g., due to bulb 30 fracture, etc.) the PCB 902 can monitor this and communicate it with a user or the controller 38.

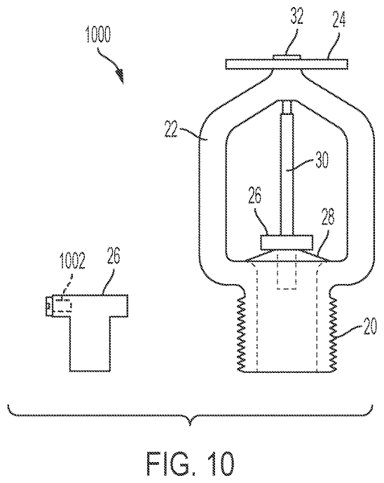

FIG. 10 depicts an example of a release assembly 1000. The release assembly 1000 can couple with the nozzle 18. The release assembly 1000 can include a first wire, a second wire, and a third wire. The first wire can couple with the base 20. The second wire can couple with the button 26. The third wire can couple with the ejector spring 28. The release assembly 1000 can include a screw 1002. The screw 1002 can extend through the button 26. The second wire can couple with the screw 1002, which couples the screw 1002 to the button 26. The base 20 and/or the ejector spring 28 can include screws 1002 functioning in the same way. The first wire, the second wire, and the third wire can be coupled with the manual activation device 34 and/or the automatic activation device 36, which supplies an electric current to the nozzle 18. The first wire and the second wire can be used to activate the bulb 30 and send electric current through the bulb 30. For example, an electric current enters the nozzle 18 via the first wire, travels through the base 20, the arms 22, the set screw 32, the bulb 30, and the button 26, and exits via the second wire. This current path through the bulb 30 can fracture the bulb 30 to release the button 26, as described above. The first wire and the third wire can be used to determine if the button 26 has been expelled from the nozzle 18. For example, in a not activated state, an electric current enters the nozzle 18 via the first wire, travels through the base 20, the arms 22, the set screw 32, the bulb 30, the button 26, and the ejector spring 28 (which is electrically coupled with the button 26), and exits via the third wire. Since the circuit is complete, a determination can be made that the bulb 30 is not fractured and the button 26 is not expelled. If the electrical current does not reach the third wire, the determination is that the bulb 30 is fractured and the button 26 has been expelled from the nozzle 18.

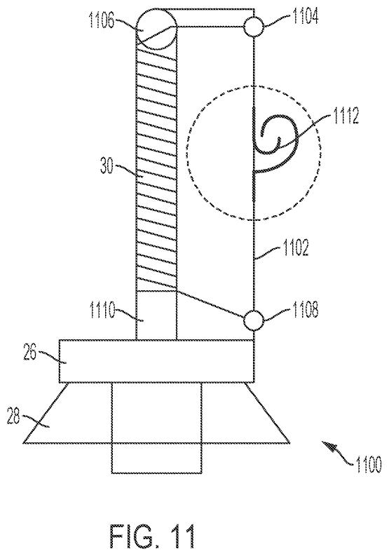

FIG. 11 depicts an example of a release assembly 1100. The release assembly 1100 can couple with the nozzle 18. The release assembly 1100 can include a link 1102. The link 1102 can include a first end 1104 that couples with a first end 1106 of the bulb 30 and a second end 1108 that couples with a second end 1110 of the bulb 30. The second end 1108 of the link 1102 can also couple with the button 26. The link 1102 can be positioned any distance away from the bulb 30. The first end 1104 couple with a first wire that further couple with the manual activation device 34 and/or the automatic activation device 36. The second end 1108 can couple with a second wire that further couples with the manual activation device 34 and/or the automatic activation device 36. The first end 1104 and the second end 1108 of the link 1102 can be electrically isolated through the link 1102 to limit current transfer through the link 1102. The manual activation device 34 and/or the automatic activation device 36 can supply electrical current to the first end 1104 or the second end 1108 of the link 1102. In an example, the electric current enters the nozzle 18 via the first end 1104 of the link 1102, travels through the first end 1106 to the second end 1110 of the bulb 30, and exits via the second end 1108 of the link 1102. In an example, the electric current enters the nozzle 18 via the second end 1108 of the link 1102, travels through the second end 1110 to the first end 1106, and exits via the first end 1104 of the link 1102. The link 1102 can break responsive to the bulb 30 fracturing. The link 1102 can include a fracture point 1112. Fracture of the link 1102 can be detected (e.g., based on detecting an open or closed circuit) to enable the controller 38 to determine the bulb 30 has fractured.

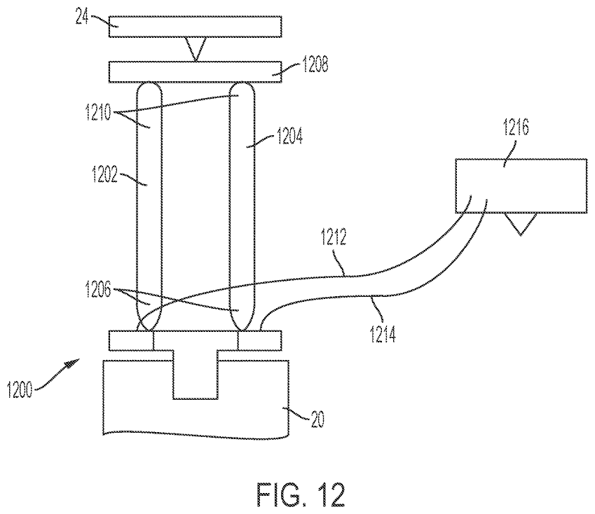

FIG. 12 depicts an example of a release assembly 1200. The release assembly 1200 can couple with the nozzle 18. The release assembly 1200 includes a first bulb 1202 (e.g., bulb 30, etc.) and a second bulb 1204 (e.g., bulb 30, etc.). The first bulb 1202 and the second bulb 1204 can be coupled with the button 26 on a first side 1206. The button 26 can be made of a non-conductive material. The first bulb 1202 and the second bulb 1204 can be coupled with a bridge 1208 on a second side 1210. The bridge 1208 can be made of a conductive material. A first wire 1212 can be coupled with the first bulb 1202 on the first side 1206 and a second wire 1214 can be coupled with the second bulb 1204 on the first side 1206. The first wire 1212 and the second wire 1214 can be coupled with a detection device 1216 (e.g., the manual activation device 34, the automatic activation device 36, etc.), which supplies electrical current to the nozzle 18. In an example, the electrical current enters the nozzle 18 via the first wire 1212, travels through the first bulb 1202, the bridge 1208, and the second bulb 1204, and exits via the second wire 1214. In an example, the electrical current enters the nozzle 18 via the second wire 1214, travels through the second bulb 1204, the bridge 1208, the first bulb 1202, and exits via the first wire 1212. Responsive to fracture of the first bulb 1202 and the second bulb 1204, the bridge 1208 can fall from the nozzle 18.

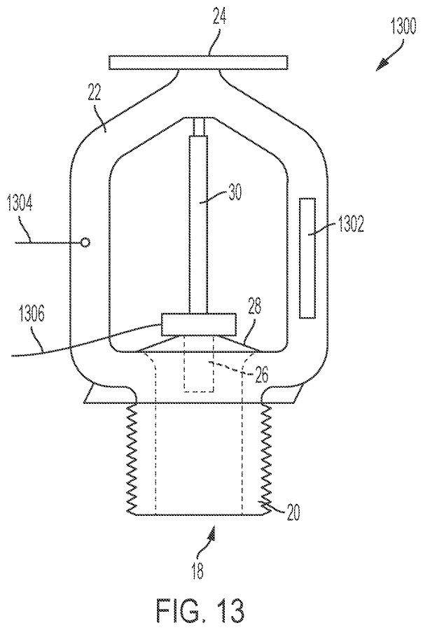

FIG. 13 depicts an example of a release assembly 1300. The release assembly 1300 couple with the nozzle 18. The release assembly 1300 can include a PCB 1302. The PCB 1302 can be coupled with one of the arms 22. The PCB 1302 can be coupled with base 20. The release assembly 1300 can include a first wire 1304 and a second wire 1306. The first wire 1304 can be coupled with a through hole defined by one of the arms 22. The hole can be positioned anywhere along the arms 22. The second wire 1306 can be coupled with the button 26. The first wire 1304 and the second wire 1306 can be coupled with the PCB 1302, which can be coupled with the manual activation device 34, the automatic activation device 36, or the controller 38, or can be coupled directly to the manual activation device 34, and/or the automatic activation device 36. An electrical current can be provided by the PCB 1302 via an internal power source, or can be provided by the manual activation device 34 and/or the automatic activation device 36. In an example, the electrical current enters the nozzle 18 via the first wire 1304, travels through the arms 22, the set screw 32, the bulb 30, and the button 26, and exits via the second wire 1306. In an example, the electrical current enters the nozzle 18 via the second wire 1306, travels through the button 26, the bulb 30, the set screw 32, and the arms 22, and exits via the first wire 1304. The PCB 1302 can determine if the bulb 30 has fractured by, for example, determining that the circuit is closed.

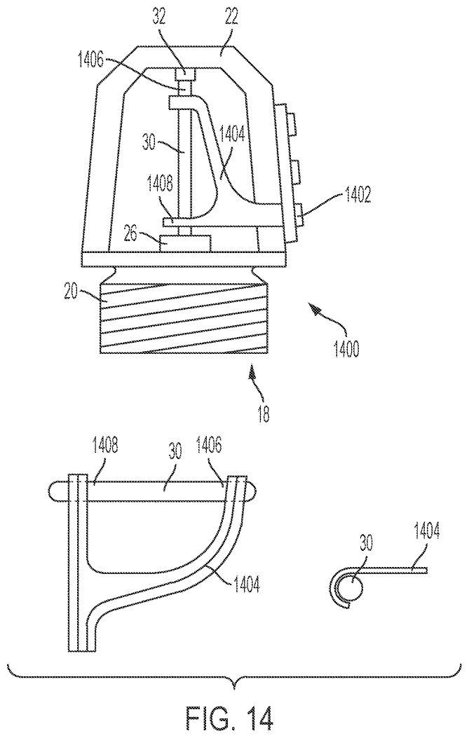

Referring to FIG. 14, a release assembly 1400 is depicted. The release assembly 1400 can couple with the nozzle 18. The release assembly 1400 can include a flex circuit 1402. The flex circuit 1402 can include an interfacing member 1404.

The interfacing member 1404 can extend from the flex circuit 1402 to couple with the bulb 30 on a first side 1406 and a second side 1408. The interfacing member 1404 can include hooks which wrap at least partially around the bulb 30 to limit movement of the flex circuit 1402 relative to the bulb 30. The flex circuit 1402 can be coupled with the manual activation device 34, the automatic activation device 36, and/or the controller 38 via a wire. The flex circuit 1402 can be remote and communicate signals wirelessly. An electric current can travel from the flex circuit 1402, and into the bulb 30 via the interfacing member 1404. The flex circuit 1402 can monitor the integrity of the bulb 30 by determining that a closed circuit is achieved by the bulb 30, the interfacing member 1404, and the flex circuit 1402. The flex circuit 1402 can also fall from the nozzle 18 during activation.

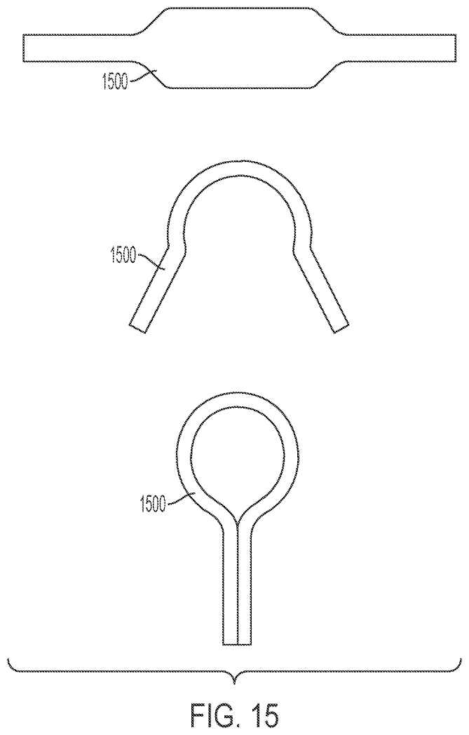

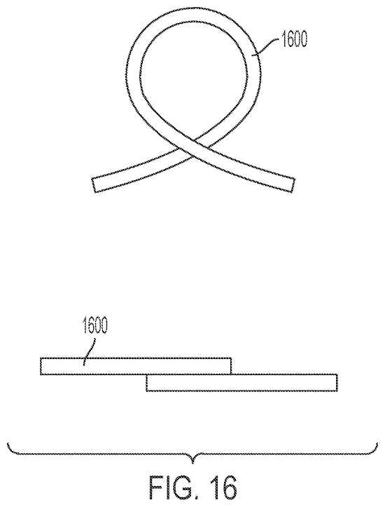

FIGS. 15 and 16 depict a metal clamp 1500 and a hose clamp 1600. A pair of metal clamps 1500 or a pair of hose clamps 1600 can be used in any of the above described variations. For example, a pair of metal clamps 1500 or a pair of hose clamps 1600 can be used in place of the first metal sheet 302 and the second metal sheet 306. The metal clamp 1500 and the hose clamp 1600 can allow for replacement of the bulb 30 after activation of the nozzle 18. The metal clamp 1500 and the hose clamp 1600 can wrap around the bulb 30 and include a portion that extends outward from the bulb 30, which accepts either the first wire 304 or the second wire 308. The metal clamp 1500 or the hose clamp 1600 can couple with a circuit board to facilitate activation and/or supervision of the bulb 30.

As utilized herein, the terms “approximately,” “about,” “substantially”, and similar terms refer to any identified range +/−10%. Such terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements can differ according to other exemplary embodiments, and that such variations are intended to be encompassed by the present disclosure.

The construction and arrangement of the release assembly as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A sprinkler system, comprising:
a sprinkler, comprising:
a base defining an inlet and an outlet;
at least one arm extending from the base;
a deflector coupled with the at least one arm;
a button that seals the outlet; and
a bulb coupled with the button between the button and the deflector, the bulb comprises a resistive trace made of an electrically conductive material to fracture the bulb responsive to an electrical current to release the button from the outlet; and
a release assembly coupled with the sprinkler, the release assembly provides the electrical current to the bulb to cause the bulb to fracture responsive to a fire condition.

2. The sprinkler system of claim 1, comprising:
the button is electrically isolated from the base.

3. The sprinkler system of claim 1, comprising:
the at least one arm comprises a first arm and a second arm; and
the release assembly comprises:
an insulated ejector spring coupled with the button and at least one of the first arm and the second arm;
a first wire coupled with one of the first arm and the second arm; and
a second wire coupled with the button, the first wire and the second wire are electrically coupled with an activation device to receive the electric current from the activation device.

4. The sprinkler system of claim 1, comprising:
the release assembly comprises:
a first metal sheet coupled with a first side of the bulb;
a second metal sheet coupled with a second side of the bulb;
a first wire coupled with the first metal sheet and selectively coupled with an activation device; and
a second wire coupled with the second metal sheet and selectively coupled with the activation device, one of the first wire and the second wire receives the electric current from the activation device.

5. The sprinkler system of claim 1, comprising:
the release assembly comprises:
a first rigid wire wrapped around an outer perimeter of the base and selectively coupled with an activation device; and
a second rigid wire wrapped around an inner perimeter of the button and selectively coupled with the activation device, the base and the button are electrically isolated from each other and one of the first rigid wire or the second rigid wire receives the electric current from the activation device.

6. The sprinkler system of claim 1, comprising:
the release assembly comprises a circuit board including a conductive outer perimeter and a conductive inner perimeter, the conductive inner perimeter couples with the button and the conductive outer perimeter couples with the base, the circuit board provides the electric current to one of the conductive inner perimeter or the conductive outer perimeter.

7. The sprinkler system of claim 1, comprising:
the release assembly comprises:
a first wire coupled with a pipe by a clamp and with an activation device; and
a second wire coupled with the sprinkler and the activation device, the electric current is supplied by the activation device to the first wire or the second wire.

8. The sprinkler system of claim 1, comprising:
the release assembly comprises:
a first wire extending through a set screw adjacent to the deflector to couple with a first side of the bulb and selectively coupled with an activation device; and
a second wire coupled with a pogo pin interfacing with a second side of the bulb and selectively coupled with the activation device, the electric current is supplied by the activation device to the first wire or the second wire.

9. The sprinkler system of claim 1, comprising:
the release assembly comprises:
a circuit board having frame clips coupled with each of a first arm and a second arm of the at least one arm; and
a button clip coupled with the button, the circuit board provides the electric current to one of the frame clips or the button clip and determines an integrity of the bulb by measuring continuity of the electric current.

10. The sprinkler system of claim 1, comprising:
the release assembly comprises:
a first wire coupled with the base and selectively coupled with an activation device;
a second wire coupled with the button and selectively coupled with the activation device; and
a third wire coupled with an ejector spring of the sprinkler and selectively coupled with the activation device, the ejector spring is electrically isolated from the base and the electric current is provided to the first wire and exits via the second wire to fracture the bulb or exits via the third wire to indicate that the button has been expelled from the outlet.

11. The sprinkler system of claim 1, comprising:
the release assembly comprises a link having a first wire coupled with a first side of the bulb and a second wire coupled with a second side of the bulb or the button, the link receives the electric current from an activation device and transfers the electric current to one of the first wire or the second wire and the link breaks at a point between the first wire and the second wire in response to the bulb fracturing.

12. The sprinkler system of claim 1, comprising:
the bulb is a first bulb; and
the release assembly comprises:
an insulating material coupled with the button to limit electrical flow through the button;
a bridge allowing electrical flow through the bridge;
a second bulb, the first bulb and the second bulb are coupled with the insulating material on a first side and the bridge on a second side;
a first wire coupled with the first side of the first bulb and selectively coupled with an activation device; and
a second wire coupled with the first side of the second bulb and selectively coupled with the activation device, the electric current is supplied by the activation device to the first wire or the second wire.

13. The sprinkler system of claim 1, comprising:
the release assembly comprises:
a circuit board coupled with one of a first arm of the at least one arm, a second arm of the at least one arm, or the base;
a first wire extending through and coupled with an aperture defined by one of the first arm and the second arm and coupled with the circuit board; and
a second wire coupled with the button and the circuit board, the electric current is supplied by the circuit board to the first wire or the second wire and the integrity of the bulb is determined by the circuit board based on continuity of the electric current.

14. The sprinkler system of claim 1, comprising:
the release assembly comprises a flex circuit coupled with the bulb by an interfacing member, the electric current is supplied by the flex circuit to a first end or a second end of the bulb and integrity of the bulb is determined by the flex circuit based on continuity of the electric current.

15. The sprinkler system of claim 1, comprising:
the release assembly comprises:
a first metal clamp coupled with a first side of the bulb and a circuit board; and
a second metal clamp coupled with a second side of the bulb and the circuit board, the electric current is supplied by the circuit board to the first metal clamp or the second metal clamp and the integrity of the bulb is determined by the circuit board based on continuity of the electric current, the first metal clamp and the second metal clamp enable a new bulb to be installed with the sprinkler without removal of the first metal clamp or the second metal clamp.

16. The sprinkler system of claim 1, comprising:
the release assembly comprises:
a first wire coupled with a first side of the bulb and selectively coupled with the activation device; and
a second wire coupled with a second side of the bulb and selectively coupled with an activation device, the bulb is electrically isolated from the button and a set screw with the deflector and the electric current is supplied by the activation device to the first wire or the second wire.

17. A fire suppression system, comprising:
at least one nozzle comprising an outlet sealed by a button and a bulb in contact with the button, the bulb comprising an electrically conductive material to cause the bulb to fracture responsive to receiving an electrical current;
a release assembly coupled with the electrically conductive material to provide the electrical current to the electrically conductive material; and
an activation device to cause the release assembly to provide the electrical current to the electrically conductive material responsive to a fire condition corresponding to a temperature less than a temperature rating of the bulb.

18. The fire suppression system of claim 17, comprising:
the release assembly comprises a first wire coupled with a frame arm of the nozzle and a second wire coupled with the button.

19. The fire suppression system of claim 17, comprising:
the temperature rating has a nominal value of 135, 155, 165, 175, 200, 214 or 286 degrees Fahrenheit.

20. The fire suppression system of claim 17, comprising:
the activation device uses the electrical current to detect that the bulb has fractured.
